(19) United States
(12) Patent Application Publication
(10) Pub. No.: US 2025/0109044 A1
(43) Pub. Date: Apr. 3, 2025

(54) Receiving Station Having Gravity-Driven Waste Separation

(71) Applicant: Scott Meyer, Genesee, ID (US)

(72) Inventor: Scott Meyer, Genesee, ID (US)

(21) Appl. No.: 18/905,121

(22) Filed: Oct. 2, 2024

Related U.S. Application Data
(60) Provisional application No. 63/542,087, filed on Oct. 2, 2023.

(51) Int. Cl. C02F 1/00

(52) U.S. Cl. CPC C02F 1/004; C02F 2201/002; C02F 2303/24

(57) ABSTRACT

Receiving stations having gravity-driven waste separation are disclosed. In some embodiments, a receiving station includes a containment vessel and a filtration assembly disposed within the containment vessel. An inflow stream engages at least one filtration member disposed at an inclination angle with respect to horizontal such that one or more filtered fluids pass through the at least one filtration member and one or more filtered objects are prevented from passing through the at least one filtration member. A debris removal is positioned to receive the one or more filtered objects, and to convey the one or more filtered objects out of the containment vessel. The filtration assembly and the debris removal assembly are configured to enable the filtered objects to be driven by gravity downwardly along the upper surface of the at least one filtration member without assistance from a mechanical removal device.

### CROSS REFERENCE TO RELATED APPLICATIONS

This patent application claims priority benefits under 35 USC § 119(e) from the following provisional patent application: U.S. Patent Application No. 63/542,087 filed on Oct. 2, 2023, which application is incorporated herein by reference.

### FIELD OF THE DISCLOSURE

The present disclosure relates generally to wastewater filtration systems, and more specifically, to receiving stations having gravity-driven waste separation mechanisms.

### BACKGROUND

In conventional receiving stations, the various grates, strainers, and bar screens remove large objects from an incoming flow stream. Such large objects may include, for example, consolidated organic materials, clumps, plastic objects, rags, branches, rocks, and anything else that will not fit through the gauge of the grate, strainer, or bar screen. A grating or bar screen is often the first filtration mechanism in initiating a wastewater flow. As part of the primary filtration flow, the grating or bar screen stage of wastewater flow is typically the first, or preliminary, level of gross filtration, often installed to receive the influent coming into a wastewater treatment plant, for example.

One downside of conventional bar screens is that this initial stage often passes too many solids, allowing those solids into the incoming wastewater flow. On the other hand, fine screens often take out too many organics which should be processed by the wastewater treatment facility. One disadvantage of removing solids with a bar screen grate is that the solids eventually must be removed from the bar screen itself to prevent blockages and clogging of the bar screen. Once some objects are removed, these arrested solids may tend to clump together, making larger plugs and blockages, such as rag balls. Prior art receiving stations are typically equipped with some type of mechanical removal device, such as brushes, rollers, drums or the like, that physically engage with and remove the accumulated large objects from the grate or bar screen to enable the receiving station to continue performing the desired filtration functionality. Accordingly, although prior art receiving stations provide desirable capabilities, there is room for improvement.

### SUMMARY

The present disclosure is directed to receiving stations having a gravity-driven waste separation mechanism. Embodiments of receiving stations in accordance with the present disclosure may advantageously reduce the complexity and costs associated with fabricating, operating, and maintaining receiving stations for performing filtration operations.

For example, in some embodiments, a receiving station for at least partially filtering an inflow stream includes: a containment vessel having an opening configured to receive an inflow stream; a filtration assembly disposed within the containment vessel and having at least one filtration member disposed at an inclination angle with respect to horizontal, the at least one filtration member positioned such that the inflow stream entering the opening of the containment vessel engages onto an upper surface thereof such that one or more filtered fluids pass through the at least one filtration member and one or more filtered objects are prevented from passing through the at least one filtration member; and a debris removal assembly having a debris chute positioned to receive the one or more filtered objects, and a screw conveyor operatively disposed proximate the debris chute to convey the one or more filtered objects along the debris chute and out of the containment vessel; wherein the filtration assembly and the debris removal assembly are configured to enable the one or more filtered objects to be driven by gravity downwardly along the upper surface of the at least one filtration member and into the debris chute without assistance from a mechanical removal device.

In some embodiments, a receiving station further includes an inflow assembly that is configured such that an initial inflow angle of the inflow stream is selected so that the inflow stream engages onto the filtration assembly to apply fluidic pressure from the inflow stream onto the one or more filtered objects to at least partially assist enable the one or more filtered objects to be driven by gravity downwardly along the upper surface of the at least one filtration member and into the debris chute without assistance from a mechanical removal device.

And in some embodiments, a receiving station further includes a spray assembly positioned proximate to the filtration assembly and configured to provide one or more spray streams into engagement with the filtration assembly. In some embodiments, the spray assembly is configured such that an initial spray angle of the one or more spray streams is selected so that the one or more spray streams engage onto the filtration assembly to apply fluidic pressure from the one or more spray streams onto the one or more filtered objects to at least partially assist the one or more filtered objects to be driven by gravity downwardly along the upper surface of the at least one filtration member and into the debris chute without assistance from a mechanical removal device.

There has thus been outlined, rather broadly, some of the embodiments of the present disclosure in order that the detailed description thereof may be better understood, and in order that the present contribution to the art may be better appreciated. There are additional embodiments that will be described hereinafter and that will form the subject matter of the claims appended hereto. In this respect, before explaining at least one embodiment in detail, it is to be understood that the various embodiments are not limited in its application to the details of construction or to the arrangements of the components set forth in the following description or illustrated in the drawings. Also, it is to be understood that the phraseology and terminology employed herein are for the purpose of the description and should not be regarded as limiting.

To better understand the nature and advantages of the present disclosure, reference should be made to the following description and the accompanying figures. It is to be understood, however, that each of the figures is provided for the purpose of illustration only and is not intended as a definition of the limits of the scope of the present disclosure. Also, as a general rule, and unless it is evidence to the contrary from the description, where elements in different figures use identical reference numbers, the elements are generally either identical or at least similar in function or purpose.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein.

FIG. 1 is a perspective view of a receiving station in accordance with an example embodiment.

FIG. 2 is a side elevational view of the receiving station of FIG. 1 in accordance with an example embodiment.

FIG. 3 is a side cross-sectional view of the receiving station of FIG. 1 (taken along line 3-3 of FIG. 1) in accordance with an example embodiment.

FIGS. 4 and 5 are end elevational views of the receiving station of FIG. 1 in accordance with an example embodiment.

FIG. 6 is a top elevational view of the receiving station of FIG. 1 in accordance with an example embodiment.

FIG. 7 is a bottom elevational view of the receiving station of FIG. 1 in accordance with an example embodiment.

FIG. 8 is a side schematic view of a filtration assembly of the receiving station of FIG. 1 in accordance with an example embodiment.

FIG. 9 is a partially-exploded, perspective view of a drive assembly of the receiving station of FIG. 1 in accordance with an example embodiment.

FIG. 10 is a perspective view of the receiving station of FIG. 1 having a catwalk in accordance with another example embodiment.

FIG. 11 is a perspective view of a receiving station in accordance with another example embodiment.

FIG. 12 is a perspective view of a receiving station in accordance with yet another example embodiment.

FIG. 13 is an enlarged, partial view of an upper portion of the receiving station of FIG. 12 in accordance with an example embodiment.

FIG. 14 is a perspective view of a receiving station in accordance with still another example embodiment.

FIG. 15 is a perspective view of a receiving station in accordance with a further example embodiment.

FIG. 16 is a side cross-sectional view of a drive assembly of the receiving station of FIG. 15 (taken along line 16-16 of FIG. 15) in accordance with an example embodiment.

FIG. 17 is a perspective view of a receiving station in accordance with another example embodiment.

FIG. 18 is a side elevational view of the receiving station of FIG. 17 in accordance with an example embodiment.

FIGS. 19 and 20 are end elevational views of the receiving station of FIG. 17 in accordance with an example embodiment.

FIGS. 21 and 22 are top and bottom elevational views of the receiving station of FIG. 17 in accordance with an example embodiment.

### DETAILED DESCRIPTION

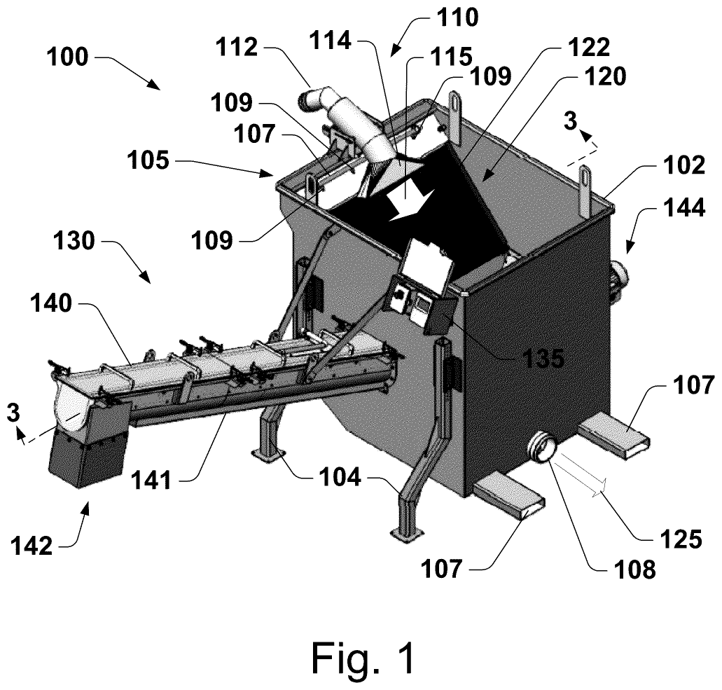

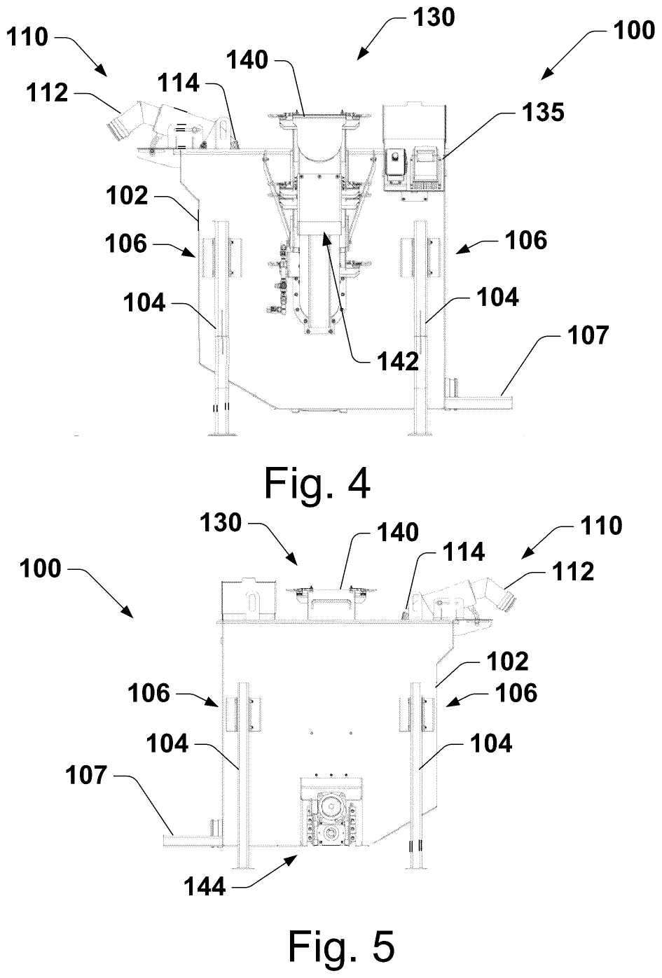

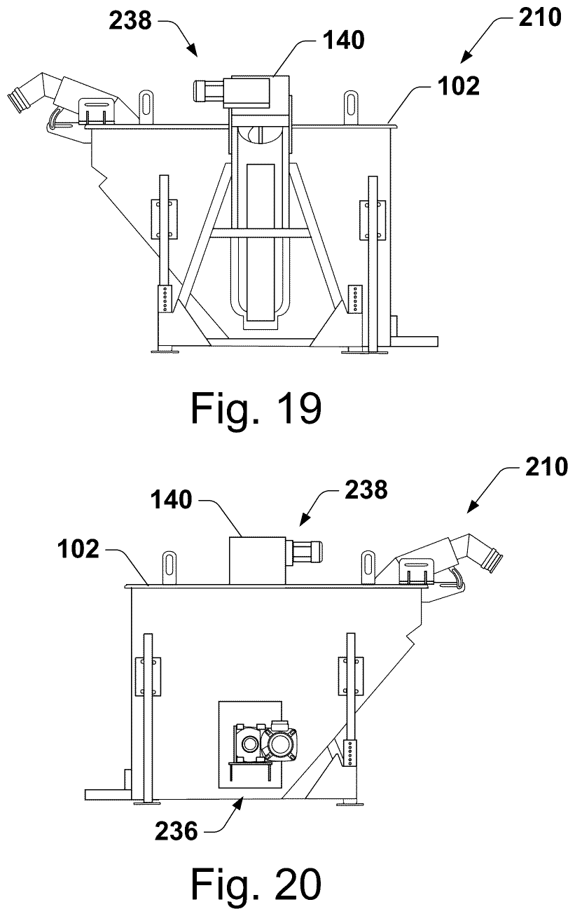

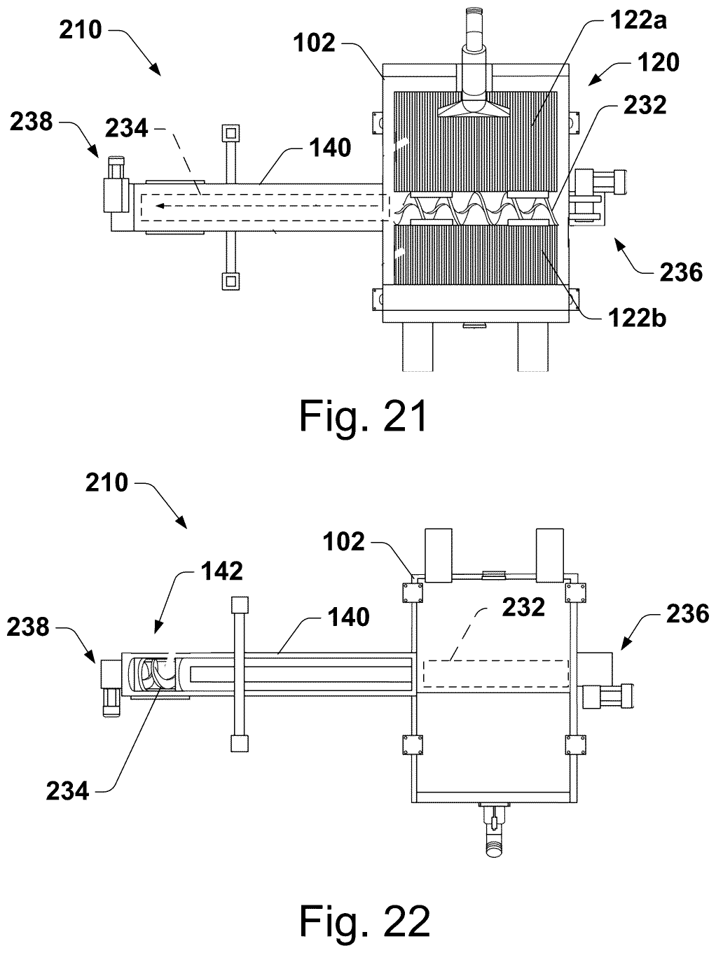

Embodiments of receiving stations having a gravity-driven waste separation mechanisms are described herein. Many specific details of certain embodiments are set forth in the following description and in FIGS. 1-22 to provide a thorough understanding of such embodiments. One skilled in the art will understand, however, that the invention may have additional embodiments, or that alternate embodiments may be practiced without several of the details described in the following description.

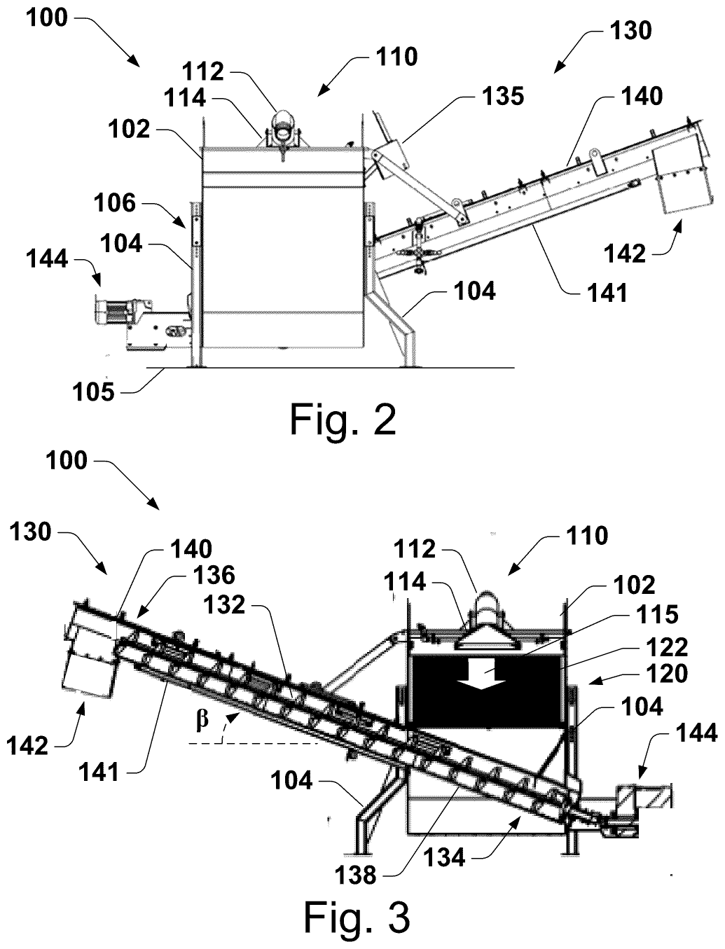

For example, FIG. 1 is a perspective view of a receiving station 100 in accordance with an example embodiment. FIGS. 2-7 show various elevational and cross-sectional views of the receiving station 100 of FIG. 1. In this embodiment, the receiving station 100 includes a hopper (or containment vessel) 102 that receives an inflow stream 115 that is to be at least partially filtered by the receiving station 100. In some embodiments, the hopper 102 may include a plurality of legs 104 that support the hopper 102 above a support surface 105 (FIG. 2), such as the ground, floor, support pad, truck bed, or other suitable structure. In some embodiments, one or more of the legs 104 may include an adjustment assembly 106 (e.g. one or more pins and a plurality of holes) to enable the lengths of the legs 104 to be independently adjusted as desired. And in some embodiments, the hopper 102 includes a pair of fork pockets 107 proximate to a bottom of the hopper 102 that facilitate transport and positioning of the receiving station 100 using a forklift or other suitable equipment. The hopper 102 further includes an outlet 108 to allow an effluent 125 to be released from the hopper 102, as described more fully below.

In some embodiments, the receiving station 100 includes an inflow assembly 110 that is configured to provide an inflow stream 115 (depicted as an arrow 115 in FIGS. 1 and 3) into the hopper 102, wherein the inflow stream 115 is intended to be filtered (or at least partially filtered) by the receiving station 100. For example, in at least some embodiments, the inflow stream 115 may be wastewater from a septic system, or alternately, may be any other suitable mixture of fluids and solid debris. As further shown in FIGS. 1-7, in some embodiments, the inflow assembly 110 includes a supply pipe 112 that may be operatively coupled to a source of wastewater (or other suitable mixture) (e.g. a supply truck, a holding tank, a pump, etc.), and a supply nozzle 114 that at least partially shapes or widens the inflow stream 115 as it is introduced into the hopper 102.

In some embodiments, the inflow assembly 110 is adjustable such that an initial inflow angle u of the inflow stream 115 with respect to vertical is variably adjustable to a desired value. For example, in some embodiments, the initial inflow angle u of the inflow stream 115 may have a value within a range of approximately 20 degrees to approximately 30 degrees from vertical. In other embodiments, in other embodiments, other values of initial inflow angle u may be employed. In some embodiments, the initial inflow angle u of the inflow stream 115 may be selected, along with other variables of the receiving station 100, to at least partially assist in the removal of filtered objects 124 from the inflow stream 115.

It will be appreciated that the inflow assembly 110 may have a variety of suitable configurations and is not necessarily limited to the particular embodiment shown in FIGS. 1-7. Similarly, in alternate embodiments, the inflow assembly 110 may be entirely separate from (or eliminated from) the receiving station 100.

As further shown in FIGS. 1-7, the receiving station 100 further includes a filtration assembly 120 disposed within the hopper 102. In some embodiments, the filtration assembly 120 includes one or more filtration devices 122 that engage with the inflow stream 115 and at least partially filter objects or debris from the inflow stream 115.

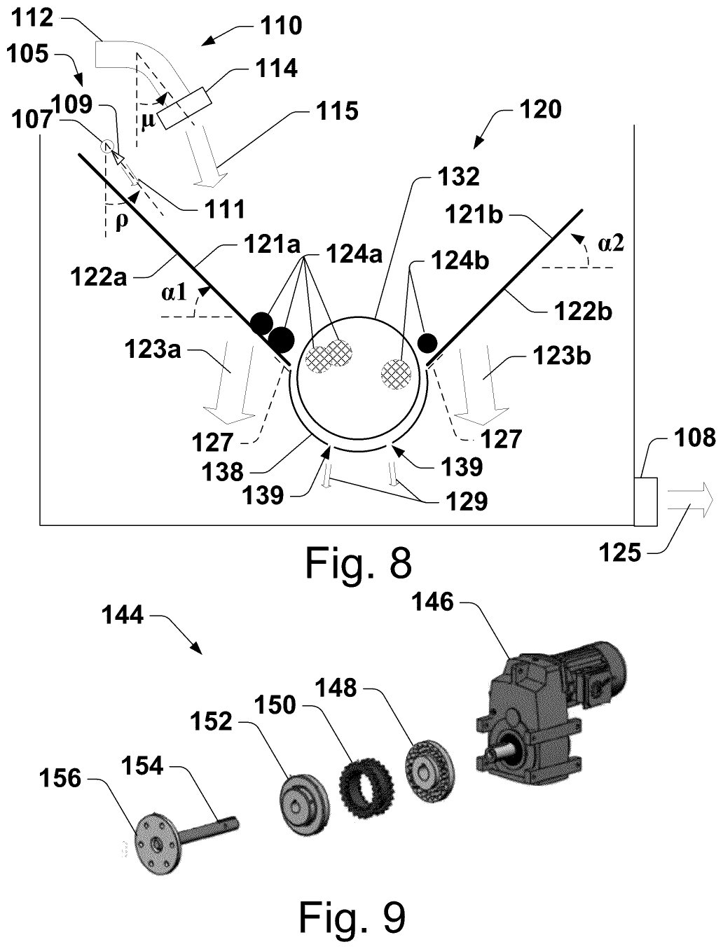

More specifically, FIG. 8 is a side schematic view of the filtration assembly 120 of the receiving station 100 of FIG. 1 in accordance with an example embodiment. In some embodiments, the filtration assembly 120 includes a plurality of filtration members 122a, 122b, each filtration member 122a, 122b being disposed at an inclination angle α1, α2 with respect to horizontal. As the inflow stream 115 engages with an upper surface 121a, 121b of the filtration members 122a, 122b, the filtration members 122a, 122b are configured to capture filtered objects 124a, 124b from the inflow stream 115, while allowing filtered liquids 123a, 123b to pass through the filtration members 122a, 122b and into the hopper 102. Eventually, the filtered liquids 123a, 123b are released from the hopper 102 via the outlet 108 to form the effluent 125.

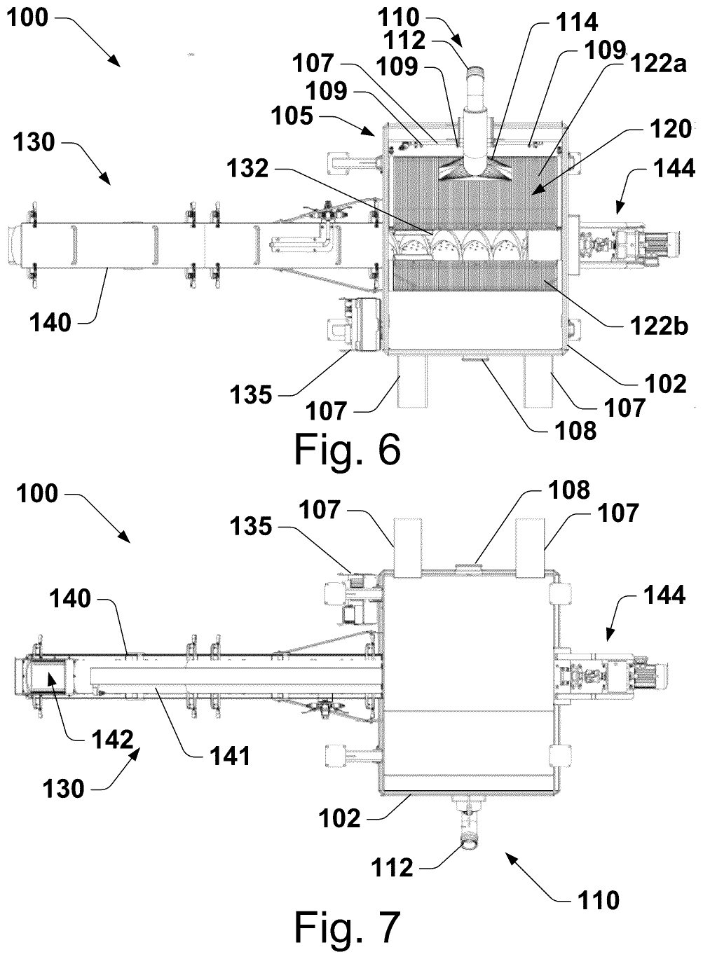

In some embodiments, the filtration members 122a, 122b may be identical, however, in other embodiments, the filtration members 122a, 122b may be different. For example, as best shown in FIG. 6, in some embodiments, a first one of the filtration members 122a may include a bar grate, and a second one of the filtration members 122b may include a perforated plate. In some embodiments, the receiving station 100 may have only one filtration member 122a, while the other filtration member 122b is replaced with a solid plate or covering. In some embodiments, depending upon the sizes of the filtration members 122a, 122b, the filtration assembly 120 may also include one or more shrouds 127 (shown in dotted lines) that extend between a lower edge of the filtration members 122a, 122b to an upper edge of the debris chute 138 to at least partially direct the filtered objects 124a, 124b into the debris chute 138. In other embodiments, however, the filtration members 122a, 122b may be sized to extend to the debris chute 138, and the one or more shrouds 127 may be eliminated.

It will be appreciated that the inclination angles α1, α2 of the filtration members 122a, 122b may be varied as desired. For example, in some embodiments, the inclination angles α1, α2 of the filtration members 122a, 122b may be approximately equal, while in other embodiments, the inclination angles α1, α2 of the filtration members 122a, 122b may be different. In some embodiments, the inclination angles α1, α2 may have values within a range of approximately 40 degrees to approximately 45 degrees. Of course, in other embodiments, other values of inclination angles α1, α2 may be employed.

As best shown in FIGS. 1, 6, and 8, in some embodiments, the receiving station 100 may further include a spray assembly 105 having one or more spray supply pipes 107 positioned proximate to an upper end of at least one of the filtration members 122a, 122b. For example, in the embodiment shown in FIG. 1, the spray supply pipe 107 of the spray assembly 105 is positioned proximate to the inflow assembly 110 near the upper end of the first filtration member 122a, extending transversely across the upper end of the first filtration member 122a. The spray supply pipe 107 may be coupled to a source of spray fluid, such as a source of fresh water or other suitable spray fluid. A plurality of spray nozzles 109 (three visible in FIG. 6) extend outwardly from the spray supply pipe 107, each spray nozzle 109 providing a spray stream 111 (FIG. 8) onto the upper surface of the filtration member 122a. The spray streams 111 emanating from the spray nozzles 109 of the spray assembly 105 may be configured to at least partially traverse downwardly over the upper surface of the filtration member 122a, and to at least partially impinge upon the one or more filtered objects 124 that are captured on the upper surface of the filtration member 122a, providing fluidic pressure that helps to urge the one or more filtered objects 124 downwardly along the filtration member 122a and into the debris chute 138. It will be appreciated that although only one spray supply pipe 107 is depicted in FIG. 8, in further embodiments, the spray assembly 105 may include additional spray supply pipes 107, such as an additional spray supply pipe 107 that provides one or more spray streams 111 onto the second filtration member 122b.

In some embodiments, the spray assembly 105 is adjustable such that an initial spray angle ρ of the one or more spray streams 111 with respect to vertical is variably adjustable to a desired value. For example, in some embodiments, the initial spray angle ρ of the one or more spray streams 111 may have a value within a range of approximately 35 degrees to approximately 65 degrees from vertical. In other embodiments, in other embodiments, other values of initial spray angle ρ may be employed. In some embodiments, the spray assembly 105 may be a freshwater system, with the spray supply pipe 107 disposed along a top edge of the hopper 102, with the one or more spray nozzles 109 evenly spaced. In some embodiments, the spray assembly 105 may be adjustable for performance reasons, and it may aid in separating organic waste or other solids that are intended to remain in the effluent 125 from the filtered objects 124 (e.g. trash), and may further help to keep the hopper 102 clean as the one or more spray streams 111 wash the filtered objects 124 free of sludge or other matter that may be present in the inflow stream 115 that are intended to remain within the effluent 125. In some embodiments, the initial spray angle p of the one or more spray streams 111 may be selected, along with other variables of the receiving station 100, to at least partially assist in the removal of filtered objects 124 from the inflow stream 115, and the subsequent conveyance and removal of the filtered objects 124 from the receiving station 100.

As further shown in FIGS. 1-8, the receiving station 100 further includes a debris removal assembly 130 that is configured to remove the filtered objects 124 from within the hopper 102. As best shown in FIG. 3, in some embodiments, the debris removal assembly 130 includes a screw conveyor 132 that is generally disposed at a tilt angle β with respect to horizontal, the screw conveyor 132 having a lower end portion 134 that is disposed within the hopper 102 and extending outwardly to an upper end portion 136 that is disposed outside the hopper 102. In some embodiments, the tilt angle β may be approximately 20 degrees, however, in other embodiments, other suitable values of tilt angle β may be employed.

The screw conveyor 132 of the debris removal assembly 130 may have a variety of suitable embodiments. For example, in some embodiments, the screw conveyor 132 comprises a shaft-less screw conveyor. In other embodiments, however, the screw conveyor 132 may comprise a shafted screw conveyor, or an auger, or any other suitable implementation. In some embodiments, the screw conveyor 132 may have a pitch of 6-12 inches between blade peaks of the screw conveyor at the same radial position, or any other suitable configuration.

The debris removal assembly 130 further includes a debris chute (or collecting channel) 138 (FIGS. 3, 8) that extends at least partially around the screw conveyor 132. The debris chute 138 is positioned proximate to lower end portions of the filtration members 122a, 122b, and is positioned to receive the filtered objects 124 that are separated from the inflow stream 115 by the filtration members 122a, 122b to facilitate capture and removal of the filtered objects 124 from within the hopper 102, as described more fully below. As further shown in FIG. 8, in some embodiments, the debris chute 138 may include a plurality of perforations 139 (e.g. holes, slots, screens, or other suitable perforations) to permit additional liquids 129 (see FIG. 8) that may be entrained or captured by the debris chute 138 to drain out of the debris chute 138 as the screw conveyor 132 moves the filtered objects 124 along the debris chute 138. It will be appreciated that the perforations 139 may be sized to prevent the one or more filtered objects 124 from exiting from the debris chute 138, but may permit smaller objects and the additional fluids 129 to escape from the debris chute 138 and enter the hopper 102.

In some embodiments, a housing 140 surrounds and protects those portions of the screw conveyor 132 and the debris chute 138 that extend outwardly from the hopper 102, wherein the housing 140 includes a debris exit port 142 disposed proximate to the upper end portion 136 of the screw conveyor 132. In some embodiments, the housing 140 includes a liquid return tray 141 disposed therein below the screw conveyer 132 and the debris chute 138 to return liquids, such as the additional liquids 129, that are drained from the debris chute 138 as the filtered objects 124 are conveyed by the screw conveyer 132 back to the hopper 102.

In some embodiments, a drive assembly 144 is operatively coupled to the lower end portion 134 of the screw conveyor 132 to provide a rotational force that rotates the screw conveyor 132 of the debris removal assembly 130. And in some embodiments, a control box 145 is positioned on an outer surface of the hopper 102 and is operatively coupled to the drive assembly 144 to provide control signals to the drive assembly 144 during operation of the receiving station 100.

It will be appreciated that the drive assembly 144 may have a variety of suitable implementations. For example, FIG. 9 is a partially-exploded, perspective view of the drive assembly 144 of the receiving station 100 of FIG. 1 in accordance with an example embodiment. In some embodiments, the drive assembly 144 includes an electric motor 146 that is coupled to and rotates a first drive hub 148, and a drive sleeve 150 that is engaged between the first drive hub 148 and a second drive hub 152. In some embodiments, a drive shaft 154 is engaged with the second drive hub 152, and a drive plate 156 is coupled between the drive shaft 154 and the lower end portion 134 of the screw conveyor 132. Accordingly, as the electric motor 146 of the drive assembly 144 rotates the drive plate 156, the screw conveyor 132 is operatively rotated within the debris chute 138.

As noted above, the drive assembly 144 is not limited to the particular embodiment described herein. For example, in some alternate embodiments, the drive assembly 144 may include a combustion engine, hydraulic components, pneumatic components, or any suitable combination of components. In some embodiments, the drive assembly 144 may include a 3 HP Nord gear reduction drive with Lenze VFD Control that accomplishes a variable speed screw of the screw conveyor 132 with variable control from 6-28 RPMs.

In operation, as the inflow stream 115 is introduced into the hopper 102 of the receiving station 100 (e.g. using the inflow assembly 110 or other suitable apparatus), the drive assembly 144 is actuated (e.g. using the control box 145) to cause the screw conveyor 132 to rotate within the debris chute 138. As the inflow stream 115 engages with one or more of the filtration members 122a, 122b of the filtration assembly 120, the filtered objects 124 are separated from filtered liquids 123a, 123b. More specifically, the filtered liquids 123a, 123b pass through the one or more filtration members 122a, 123a and are collected in a lower portion of the hopper 102, and are then released through the outlet 108 of the hopper 102 as the effluent 125.

As best shown in FIG. 8, the filtration assembly 120 is configured such that the filtration member 122a is inclined at the inclination angle α1 so that as the filtered objects 124 are separated from the inflow stream 115, the filtered objects 124 are driven by gravity (and possibly also at least partially by fluidic pressure from the inflow stream 115) downwardly along an upper surface of the filtration member 122a and into the debris chute 138. Similarly, the filtration assembly 120 may also be configured such that the filtration member 122b is inclined at the inclination angle α2 so that additional filtered objects 124 are separated from the inflow stream 115 by the filtration member 122b and may be driven by gravity (and possibly also at least partially by fluidic pressure from the inflow stream 115) downwardly along an upper surface of the filtration member 122b and into the debris chute 138. The filtered objects 124 are then engaged by the rotating screw conveyor 132, which propels the filtered objects 124 upwardly along the debris chute 138, moving the filtered objects 124 from within the hopper 102 upwardly through the housing 140 and expelling the filtered objects 124 through the debris exit port 142. As the filtered objects 124 are expelled through the debris exit port 142, the filtered objects 124 may be collected for proper disposal.

It will be appreciated that by proper selection of the inclination angle α1 of the filtration member 122a (and possibly also by proper selection of the inclination angle α2 of the filtration member 122b), the filtered objects 124 may be transported by gravity (and possibly also at least partially by fluidic pressure from the inflow stream 115 and/or from the one or more spray streams 111 of the spray assembly 105) into the debris chute 138 for removal from the hopper 102 by the debris removal assembly 130 without the need for any other type of mechanical removal device, such as brushes, rollers, drums or the like, that move across (or traverse over) one or more portions of the upper surfaces 121a, 121b of the filtration members 122a, 122b to physically engage with and remove the filtered objects 124 from the filtration member 122a (and 122b). Accordingly, the filtration assembly 120 advantageously enables the receiving station 100 to continue performing the desired filtration functionality while eliminating one or more mechanical removal devices (e.g. brushes, rollers, drums or the like) that are used by prior art receiving stations to physically engage and move the filtered objects 124 from the surface of the grates or bar screens. In this way, embodiments of receiving stations in accordance with the present disclosure may advantageously reduce the complexity and costs associated with fabricating, operating, and maintaining receiving stations for performing filtration operations.

In some embodiments, wherein the receiving station 100 includes the inflow assembly 110, the initial inflow angle u may be selected and/or variably adjusted in accordance with other variables of the receiving station 100 (e.g. filtration members 122, inclination angles α1, α2, etc.), and possibly other variables of the environment (e.g. type of inflow stream 115, size of filtered objects 124, etc.), such that the fluidic pressure of the inflow stream 115 on the filtered objects 124 at least partially assists in the removal of the filtered objects 124 from the inflow stream 115 and conveyance of the filtered objects 124 along the upper surface 121 of the filtration members 122 into the debris chute 138 for removal by the screw conveyor 132.

And in some embodiments, wherein the receiving station 100 includes the spray assembly 105, the initial spray angle ρ of the one or more spray streams 111 may be selected and/or variably adjusted in accordance with other variables of the receiving station 100 (e.g. filtration members 122, inclination angles α1, α2, etc.), and possibly other variables of the environment (e.g. type of inflow stream 115, size of filtered objects 124, etc.), such that the fluidic pressure of the one or more spray streams 111 on the filtered objects 124 at least partially assists in the removal of the filtered objects 124 from the inflow stream 115 and conveyance of the filtered objects 124 along the upper surface 121 of the filtration members 122 into the debris chute 138 for removal by the screw conveyor 132.

It will be appreciated that receiving stations having a gravity-driven waste separation mechanism (which may or may not include fluidic-pressure assistance from the inlet stream 115 and/or the one or more spray streams 111) for removal of filtered objects from an inflow stream are not limited to the particular embodiments described above. In the following discussion, additional embodiments of receiving stations in accordance with the present disclosure will be described. For the sake of brevity, the following description will primarily focus on new or different aspects of such additional embodiments.

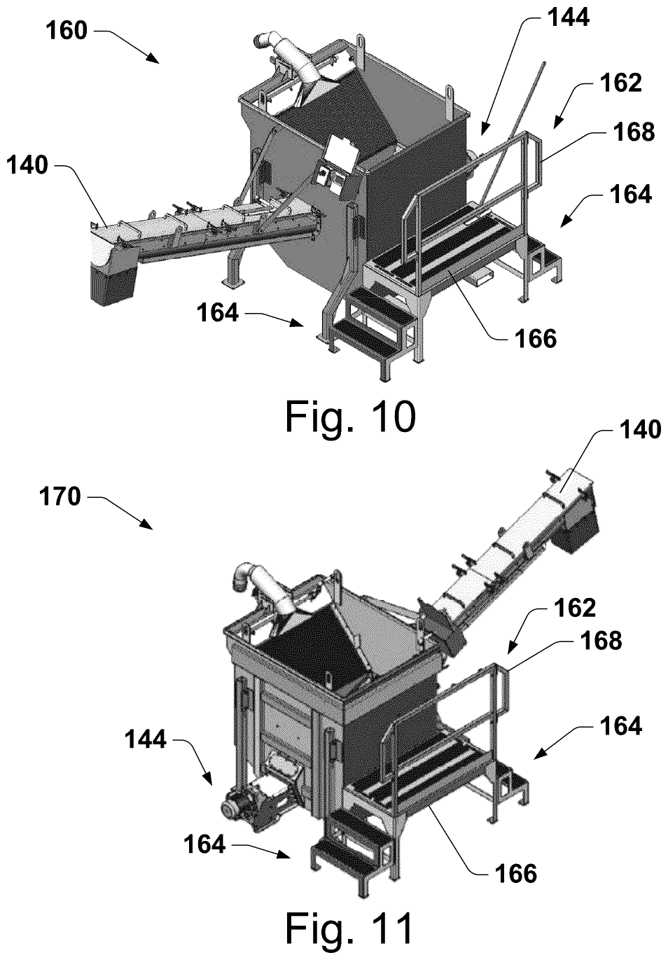

For example, FIG. 10 is a perspective view of a receiving station 160 in accordance with another example embodiment. In this embodiment, the receiving station 160 may have all the same components and functionalities as the receiving station 100 of FIG. 1, however, the receiving station 160 further includes a catwalk 162. In some embodiments, the catwalk 162 includes one or more sets of stairs 164 that ascend to a platform 166, and a guard rail 168 that enhances safety of an operator during use of the catwalk 162. The catwalk 162 may advantageously facilitate an operator's ability to control and monitor operations of the receiving station 160. In some embodiments, the catwalk 162 may comprise an Occupational Safety and Health Administration (OSHA)-compliant catwalk for maintenance, viewing, and other operational activities.

Similarly, FIG. 11 is a perspective view of a receiving station 170 in accordance with another example embodiment. In this embodiment, the receiving station 170 may have all the same components and functionalities as the receiving station 160 of FIG. 10 (including the catwalk 162), however, in this embodiment, the orientation of the debris removal assembly 130 is reversed by 180 degrees such that the housing 140 projects outwardly from a right-hand side of the hopper 102 (rather than a left-hand side as shown in FIG. 10). Similarly, in this embodiment, the drive assembly 144 projects outwardly from a left-hand side of the hopper 102 (rather than a right-hand side as shown in FIG. 10). It will be appreciated that the configuration of receiving stations in accordance with the present disclosure may be changed or adjusted as needed to better suit the facilities and environments in which they are intended to operate.

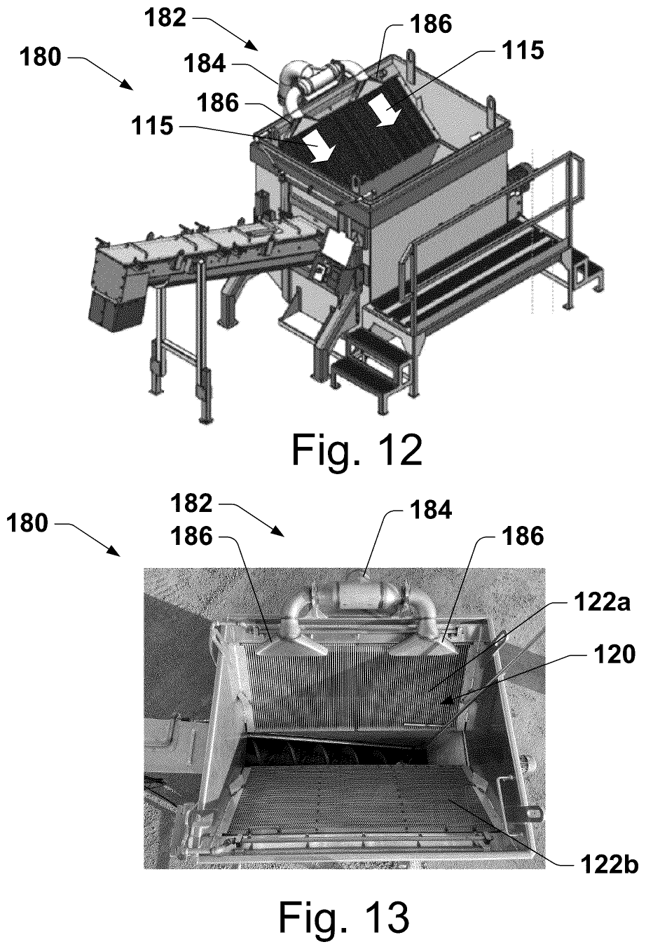

FIG. 12 is a perspective view of a receiving station 180 in accordance with yet another example embodiment. FIG. 13 is an enlarged, partial view of an upper portion of the receiving station 180 of FIG. 12. In this embodiment, the receiving station 180 may have all the same components and functionalities as the receiving station 160 of FIG. 10, however, in this embodiment, the receiving station 180 includes an inflow assembly 182 that is configured to provide a pair of inflow streams 115 (FIG. 12) into the hopper 102. More specifically, the inflow assembly 182 of the receiving station 180 includes a supply pipe 184 that branches to a pair of supply nozzles 186, each supply nozzle 186 being configured to provide a shaped and widened inflow stream 115 into the hopper 102. In some embodiments, the inflow assembly 182 of the receiving station 180 may include a supply pipe 184 that is 6 inches in diameter that branches into two offload pipes that are each 4 inches in diameter, each offload pipe ending in a fan spreader (or supply nozzle 186). In some embodiments, the inflow assembly 182 may be capable of power offloading vacuum trucks with a single 6 inch diameter offload at a rate of up to 800 gallons per minute.

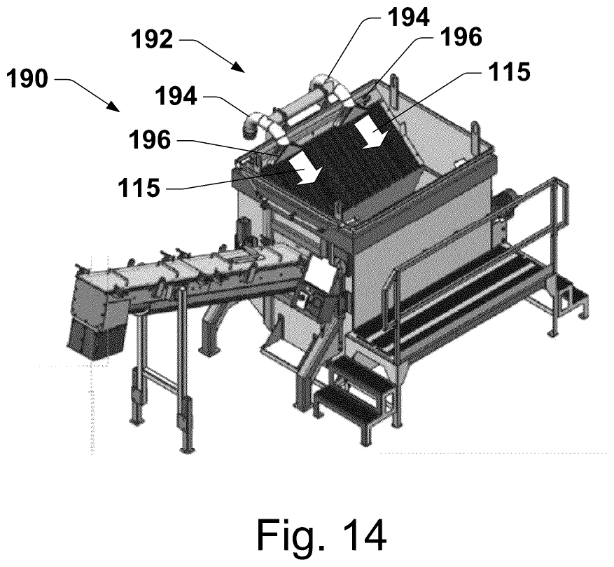

Similarly, FIG. 14 is a perspective view of a receiving station 190 in accordance with still another example embodiment. In this embodiment, the receiving station 190 includes an inflow assembly 192 that is again configured to provide a pair of inflow streams 115 into the hopper 102. More specifically, in some embodiments, the inflow assembly 192 of the receiving station 190 includes a pair of supply pipes 194, each supply pipe 194 leading to a supply nozzle 196 that is configured to provide a shaped and widened inflow stream 115 into the hopper 102. In some embodiments, the inflow assembly 192 may be capable of power offloading vacuum trucks with two 4 inch diameter supply pipes 194 at the same time at a rate of up to 800 gallons per minute

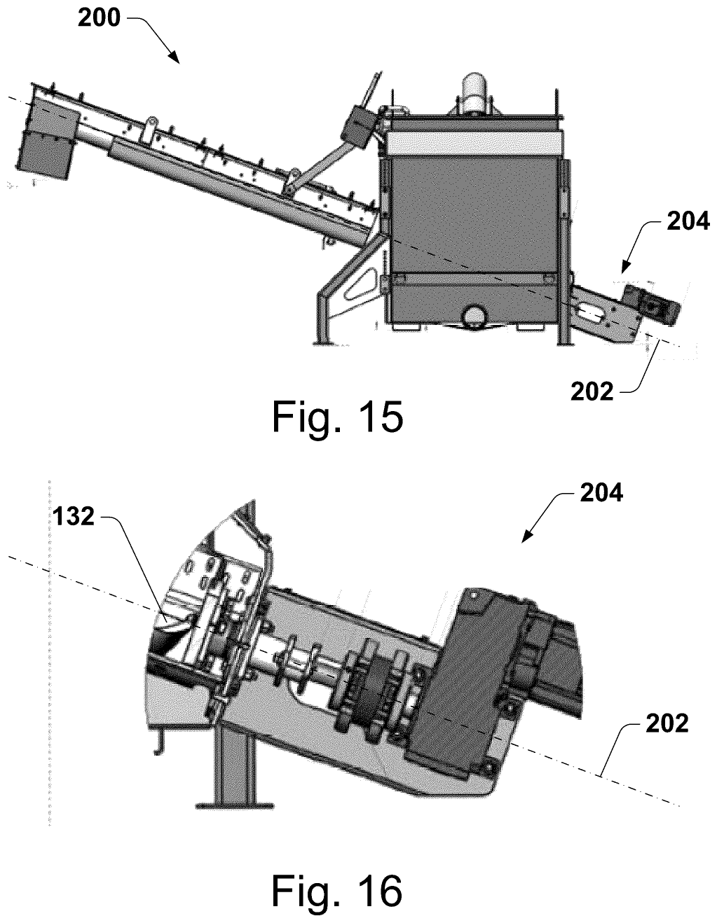

FIG. 15 is a side elevational view of a receiving station 200 in accordance with a further example embodiment. FIG. 16 is a side cross-sectional view of a drive assembly 204 of the receiving station 200 of FIG. 15. In this embodiment, the receiving station 200 may have all the same components and functionalities as the receiving station 100 of FIGS. 1-9, however, in this embodiment, the debris removal assembly 130 is reconfigured such that the drive assembly 204 is substantially aligned with a longitudinal axis 202 of the screw conveyor 132.

In some embodiments, receiving stations in accordance with the present disclosure may include an inlet (or inflow assembly) for receiving a flow stream (or inflow stream 115); and a grating (or filtration member 122) for receiving the flow stream by gravity from the inlet and removing at least some solids (or filtered objects 124) from the flow stream on a surface of the grating. In some embodiments, the grating may be multiple different grate sections (e.g. filtration members 122a, 122b) disposed at respective angles (e.g. inclination angles α1, α2) to a collecting channel (or debris chute 138); the respective angles disposed to move the at least some solids removed from the flow stream to the collecting channel by gravity. In at least some embodiments, the grating allows liquids, fluids, and flowables to pass through the grating as filtrates for collection and outflow from the receiving station through a first outlet (or outlet 108).

In some embodiments, an auger (or screw conveyor 132) in the collecting channel transports the at least some solids removed from the flow stream for output from the receiving station via a second outlet (e.g. housing 140 and/or debris exit port 142). In some embodiments, the receiving station may have the collecting channel and the auger disposed at an angle with respect to a bottom of the receiving station, in order to form a jump auger within the receiving station for lifting the at least some solids from the receiving station to an external conveyance. For example, in some embodiments, the external conveyance may be a truck, a train, a conveyor, a treatment plant, a silo, and so forth.

In some embodiments, a receiving station may have a jump auger (or screw conveyor 132) disposed at a consistent angle (or tilt angle β) from the horizontal, and the collecting channel (or debris chute 138) is also disposed at the consistent angle. In some embodiments, a receiving station may further include one or more angled shrouds (shroud 127), each angled shroud disposed between a lower edge of a respective grate section (filtration member 122) and the collecting channel that is disposed at the consistent angle, the angled shrouds at least partially directing the solids (or filtered objects 124) from the respective grate sections to the collecting channel.

In some embodiments, the receiving station includes a separate fluid channel (or liquid return tray 141), usually positioned below the screw conveyor 132 within the housing 140, for gravity collection of liquids, fluids, and flowables during the transport of the solids (or filtered objects 124) out of the receiving station to the second outlet (or debris exit port 142). The separate fluid channel may return liquids, fluids, and flowables that may accumulate in the screw conveyor during transport of the solids, for output at the first outlet (or outlet 108) of the receiving station, which outputs the effluent 125.

In some embodiments, a receiving station may have one or more of the filtration members 122a, 122b disposed at inclination angles α1, α2 between 20-80 degrees from the horizontal. As noted above, however, in some embodiments, the inclination angles α1, α2 may have values within a range of approximately 40 degrees to approximately 45 degrees. And in some embodiments, the inclination angles α1, α2 may have values within a range of approximately 40 degrees to approximately 50 degrees.

In addition, in some embodiments, the filtration members 122 may include grate sections (or bar grating), and may have variable and user-selectable slot spacings between bars of the bar grates, for selecting a threshold size of a solid (or filtered object 124) that can pass through the grating, or on the other hand, a threshold size of a solid that can be removed from the inflow stream 115. In some embodiments, the filtration assembly 120 includes may include two adjacent gratings capable of sliding laterally (or side to side) with respect to each other to provide the variable and user-selectable slot spacings.

In some embodiments, the filtration members 122 may include a grate with grid bars or grate members that are mechanically adjustable to assume different diameters for providing the variable and user-selectable slot spacings. For example, in some embodiments, each grid bar or grate member may have a V-shape or upside-down V-shape cross section, wherein a width of the opening of the “V” of the V-shape is user-selectable and mechanically variable.

Thus, in various embodiments, a receiving station may include one or more bar screen grates (or filtration members 122) positioned at angles (inclination angles α1, α2). As a wastewater flow stream (or inflow stream 115) is received, liquids in the stream pass though the openings (slot spaces) in the bar screen or other grate device to an output (or outlet 108) leading to further wastewater treatment. Solids (or filtered objects 124) caught by the bar screen or grating are removed from the flow stream. Since the bar screens are disposed at an angle, gravity pulls the filtered objects making them fall to a lowest part of the bar screens, where an auger channel (or debris chute 138) catches the solids and an auger (or screw conveyor 132) transports the solids out of the receiving station via the auger (or other screw conveyor 132). In some embodiments, the filtration assembly 120 of the receiving station includes two bar screen grates that are placed at inclination angles α1, α2 on opposing sides of the collecting channel (or debris chute 138) and auger (or screw conveyor 132), forming a trough that funnels the caught and filtered solids (or filtered objects 124) down to the auger channel.

In various embodiments, a receiving station in accordance with the present disclosure may be used for processing of wastewater from food processing plants, from grain processing plants, from wineries and breweries, from sewage systems, from septic tank pumping trucks, from mines, including the processing of fracking water, from chemical plants, from mills, from fuel ethanol plants, and from lakes, rivers, dams, and surface water drainage systems, and in any other suitable environments or implementations. In some embodiments, the auger or screw conveyor in the collecting channel transports the solids at a speed that depends on the type of wastewater being processed. For example, in some embodiments, the auger or screw conveyor may have a speed of 5-15 revolutions per minute (RPM) to transport the solids away from the receiving station.

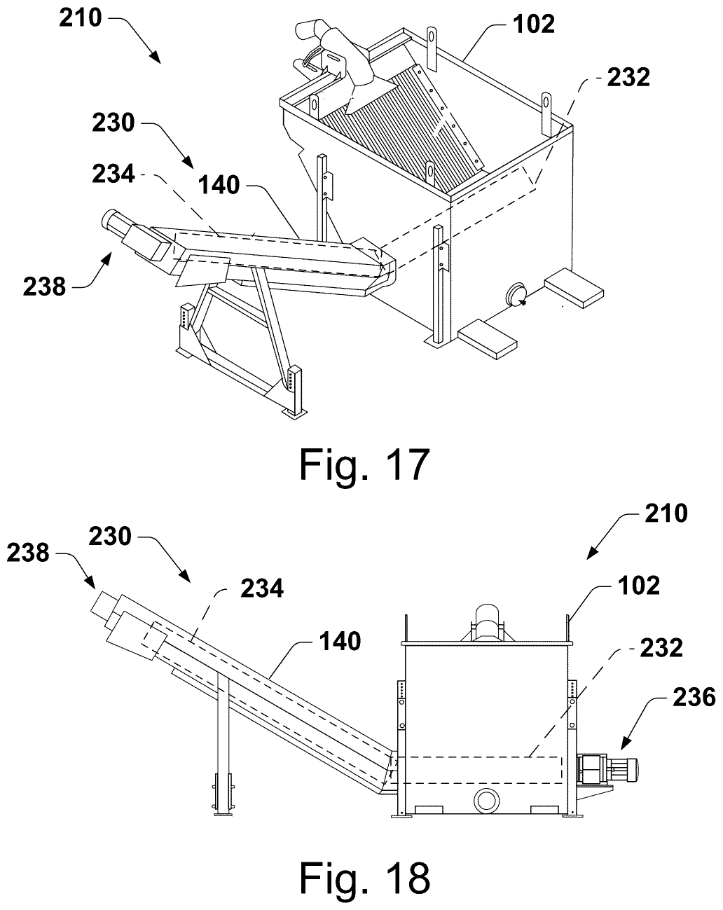

Embodiments of receiving stations having a gravity-driven waste separation mechanisms in accordance with the present disclosure may be equipped with alternate embodiments of debris removal assemblies, including but not limited to embodiments having multiple screw conveyors. For example, FIG. 17 is a perspective view of a receiving station 210 in accordance with another example embodiment. FIGS. 18-22 are various elevational views of the receiving station 210 of FIG. 17. In this embodiment, the receiving station 210 may have many of the same components and functionalities as the receiving station 100 of FIG. 1 described above, however, the receiving station 210 includes a debris removal assembly 230 having a first screw conveyor 232 and a second screw conveyor 234. In some embodiments, the first screw conveyor 232 is disposed within the hopper 102 proximate to the filtration members 122a, 122b, and is driven by a first drive assembly 236, while the second screw conveyor 234 is disposed within the housing 140 and is driven by a second drive assembly 238. In some embodiments, the first screw conveyor 232 may be approximately horizontal, and the second screw conveyor 234 is inclined at a tilt angle β.

In operation, the first and second screw conveyors 232, 234 of the debris removal assembly 230 may cooperatively remove filtered objects 124a, 124b from within the hopper 120. More specifically, the first screw conveyor 232 may receive the filtered objects 124a, 124b as they are gravity-driven from the filtration members 122a, 122b into the debris chute 138, and may convey the filtered objects 124a, 124b to a lower end of the second screw conveyor 234 proximate to a side wall of the hopper 102. The filtered objects 124a, 124b may then be conveyed by the second screw conveyor 234 up through the housing 140, to be discharged through the debris exit port 142 for proper disposal.

As noted above, in some embodiments, a receiving station may have debris removal assembly that includes a screw conveyor having a horizontal section (or first screw conveyor 232) and a rising angled section (or second screw conveyor 234), the rising angled section being disposed at an angle (or tilt angle β) from the horizontal. In some embodiments, a receiving station has a bottom auger channel (or first screw conveyor 232) that transports the solids from the wastewater flow stream to the intake of a second, rising screw conveyor (or second screw conveyor 234), which forms a conveyor transport for removing the solids (or filtered objects 124) out of the receiving station and up to a height suitable for discharging the solids to a truck or a dumpster (via the debris exit port 142).

In some embodiments, a receiving station in accordance with the present disclosure may provide removal of solids (or filtered objects 124) while allowing high flow, and in some cases washing and dewatering of solids in a process that helps to break up organic material, with soft organics returning to the stream (or effluent 125). In some embodiments, a receiving station may also include an option for top slope sheeting. For example, an optional cover can roll open over the main hopper (or containment vessel) of the receiving station. In some embodiments, the receiving station may include a debris removal assembly having a screw conveyor that extends outwardly to the left or to the right of the main hopper (or containment vessel).

Accordingly, in some embodiments, a receiving station for at least partially filtering an inflow stream includes: a containment vessel having an opening configured to receive an inflow stream; a filtration assembly disposed within the containment vessel and having at least one filtration member disposed at an inclination angle with respect to horizontal, the at least one filtration member positioned such that the inflow stream entering the opening of the containment vessel engages onto an upper surface thereof such that one or more filtered fluids pass through the at least one filtration member and one or more filtered objects are prevented from passing through the at least one filtration member; and a debris removal assembly having a debris chute positioned to receive the one or more filtered objects, and a screw conveyor operatively disposed proximate the debris chute to convey the one or more filtered objects along the debris chute and out of the containment vessel; wherein the filtration assembly and the debris removal assembly are configured to enable the one or more filtered objects to be driven by gravity downwardly along the upper surface of the at least one filtration member and into the debris chute without assistance from a mechanical removal device.

In some embodiments, the inclination angle of the at least one filtration member is within a range of approximately 40 degrees to approximately 45 degrees with respect to horizontal. And in some embodiments, the screw conveyor of the debris removal assembly is disposed at a tilt angle such that a lower end portion of the screw conveyor is disposed within the containment vessel and an upper end portion of the screw conveyor is disposed outside the containment vessel, the lower end portion being disposed proximate to the filtration assembly to receive the one or more filtered objects. In at least some embodiments, the tilt angle of the screw conveyor is within a range of approximately 15 degrees to approximately 25 degrees with respect to horizontal.

In some embodiments, the filtration assembly and the debris removal assembly are configured to enable the one or more filtered objects to be driven by gravity downwardly along the upper surface of the at least one filtration member and into the debris chute without assistance from a mechanical removal device that physically engages with and removes the one or more filtered objects from the upper surface of the at least one filtration member.

In some embodiments, the filtration assembly and the debris removal assembly are configured to enable the one or more filtered objects to be driven by gravity downwardly along the upper surface of the at least one filtration member and into the debris chute without assistance from one or more of a brush, a roller, a drum or the like that physically engages with and removes the one or more filtered objects from the upper surface of the at least one filtration member.

In addition, in some embodiments, a receiving station further includes an inflow assembly positioned proximate to the opening of the containment vessel and configured to provide the inflow stream into the containment vessel and into engagement with the filtration assembly. In some embodiments, the inflow assembly includes a supply pipe that is couplable to a source, and a supply nozzle that at least partially shapes or widens the inflow stream as it is introduced into the containment vessel. And in some embodiments, the inflow assembly is further configured such that the inflow stream engages onto the filtration assembly to enable the one or more filtered objects to be driven by gravity downwardly along the upper surface of the at least one filtration member and into the debris chute without assistance from a mechanical removal device.

Moreover, in some embodiments, a receiving station includes an inflow assembly that is configured such that an initial inflow angle of the inflow stream is selected so that the inflow stream engages onto the filtration assembly to apply fluidic pressure from the inflow stream onto the one or more filtered objects to at least partially assist enable the one or more filtered objects to be driven by gravity downwardly along the upper surface of the at least one filtration member and into the debris chute without assistance from a mechanical removal device.

In some embodiments, a receiving station further includes a spray assembly positioned proximate to the filtration assembly and configured to provide one or more spray streams into engagement with the filtration assembly. In at least some embodiments, the spray assembly includes a spray supply pipe that is couplable to a spray fluid source, and one or more spray nozzles that provide the one or more spray streams. And in some embodiments, the spray assembly is configured such that an initial spray angle of the one or more spray streams is selected so that the one or more spray streams engage onto the filtration assembly to apply fluidic pressure from the one or more spray streams onto the one or more filtered objects to at least partially assist the one or more filtered objects to be driven by gravity downwardly along the upper surface of the at least one filtration member and into the debris chute without assistance from a mechanical removal device.

In further embodiments, a receiving station for at least partially filtering an inflow stream, comprises: a containment vessel having an opening configured to receive the inflow stream; an inflow assembly positioned proximate to the opening of the containment vessel and configured to provide the inflow stream into the containment vessel; a filtration assembly disposed within the containment vessel and having at least one filtration member disposed at an inclination angle with respect to horizontal, the at least one filtration member positioned such that the inflow stream entering the opening of the containment vessel engages onto an upper surface thereof such that one or more filtered fluids pass through the at least one filtration member and one or more filtered objects are prevented from passing through the at least one filtration member; and a debris removal assembly having a debris chute positioned to receive the one or more filtered objects, and a screw conveyor operatively disposed proximate the debris chute to convey the one or more filtered objects along the debris chute and out of the containment vessel; wherein the inflow assembly, the filtration assembly, and the debris removal assembly are configured to enable the one or more filtered objects to be driven by gravity, and at least partially assisted by fluidic pressure from the inflow stream, downwardly along the upper surface of the at least one filtration member and into the debris chute without assistance from a mechanical removal device. In some embodiments, a receiving station further includes a spray assembly positioned proximate to the filtration assembly and configured to provide one or more spray streams into engagement with the filtration assembly, the spray assembly being configured such that an initial spray angle of the one or more spray streams is selected so that the one or more spray streams engage onto the filtration assembly to apply fluidic pressure from the one or more spray streams onto the one or more filtered objects to at least partially assist the one or more filtered objects to be driven by gravity downwardly along the upper surface of the at least one filtration member and into the debris chute.

In addition, in some embodiments, a receiving station for at least partially filtering an inflow stream, comprises: a containment vessel having an opening configured to receive the inflow stream; a filtration assembly disposed within the containment vessel and having at least one filtration member disposed at an inclination angle with respect to horizontal, the at least one filtration member positioned such that the inflow stream entering the opening of the containment vessel engages onto an upper surface thereof such that one or more filtered fluids pass through the at least one filtration member and one or more filtered objects are prevented from passing through the at least one filtration member; a spray assembly positioned proximate to the filtration assembly and configured to provide one or more spray streams into engagement with the filtration assembly; and a debris removal assembly having a debris chute positioned to receive the one or more filtered objects, and a screw conveyor operatively disposed proximate the debris chute to convey the one or more filtered objects along the debris chute and out of the containment vessel; wherein the filtration assembly, the spray assembly, and the debris removal assembly are configured to enable the one or more filtered objects to be driven by gravity, and at least partially assisted by fluidic pressure from the one or more spray streams, downwardly along the upper surface of the at least one filtration member and into the debris chute without assistance from a mechanical removal device. In some embodiments, a receiving station further includes an inflow assembly positioned proximate to the opening of the containment vessel and configured to provide the inflow stream into the containment vessel, the inflow assembly being configured such that an initial inflow angle of the inflow stream is selected so that the inflow stream engages onto the filtration assembly to apply fluidic pressure from the inflow stream onto the one or more filtered objects to at least partially assist the one or more filtered objects to be driven by gravity downwardly along the upper surface of the at least one filtration member and into the debris chute.

While various embodiments have been described, those skilled in the art will recognize modifications or variations which might be made without departing from the present disclosure. The examples illustrate the various embodiments and are not intended to limit the present disclosure. Therefore, the description and claims should be interpreted liberally with only such limitation as is necessary in view of the pertinent prior art.

What is claimed is:

1. A receiving station for at least partially filtering an inflow stream, comprising:
a containment vessel having an opening configured to receive the inflow stream;
a filtration assembly disposed within the containment vessel and having at least one filtration member disposed at an inclination angle with respect to horizontal, the at least one filtration member positioned such that the inflow stream entering the opening of the containment vessel engages onto an upper surface thereof such that one or more filtered fluids pass through the at least one filtration member and one or more filtered objects are prevented from passing through the at least one filtration member; and
a debris removal assembly having a debris chute positioned to receive the one or more filtered objects, and a screw conveyor operatively disposed proximate the debris chute to convey the one or more filtered objects along the debris chute and out of the containment vessel;
wherein the filtration assembly and the debris removal assembly are configured to enable the one or more filtered objects to be driven by gravity downwardly along the upper surface of the at least one filtration member and into the debris chute without assistance from a mechanical removal device.

2. The receiving station of claim 1, wherein the inclination angle of the at least one filtration member is within a range of approximately 40 degrees to approximately 45 degrees with respect to horizontal.

3. The receiving station of claim 1, wherein the screw conveyor of the debris removal assembly is disposed at a tilt angle such that a lower end portion of the screw conveyor is disposed within the containment vessel and an upper end portion of the screw conveyor is disposed outside the containment vessel, the lower end portion being disposed proximate to the filtration assembly to receive the one or more filtered objects.

4. The receiving station of claim 3, wherein the tilt angle of the screw conveyor is within a range of approximately 15 degrees to approximately 25 degrees with respect to horizontal.

5. The receiving station of claim 1, wherein the filtration assembly and the debris removal assembly are configured to enable the one or more filtered objects to be driven by gravity downwardly along the upper surface of the at least one filtration member and into the debris chute without assistance from a mechanical removal device that physically engages with and removes the one or more filtered objects from the upper surface of the at least one filtration member.

6. The receiving station of claim 1, wherein the filtration assembly and the debris removal assembly are configured to enable the one or more filtered objects to be driven by gravity downwardly along the upper surface of the at least one filtration member and into the debris chute without assistance from one or more of a brush, a roller, a drum or the like that physically engages with and removes the one or more filtered objects from the upper surface of the at least one filtration member.

7. The receiving station of claim 1, further comprising an inflow assembly positioned proximate to the opening of the containment vessel and configured to provide the inflow stream into the containment vessel and into engagement with the filtration assembly.

8. The receiving station of claim 7, wherein the inflow assembly includes a supply pipe that is couplable to a source, and a supply nozzle that at least partially shapes or widens the inflow stream as it is introduced into the containment vessel.

9. The receiving station of claim 7, wherein the inflow assembly is further configured such that an initial inflow angle of the inflow stream is selected so that the inflow stream engages onto the filtration assembly to apply fluidic pressure from the inflow stream onto the one or more filtered objects to at least partially assist the one or more filtered objects to be driven by gravity downwardly along the upper surface of the at least one filtration member and into the debris chute without assistance from a mechanical removal device.

10. The receiving station of claim 1, further comprising a spray assembly positioned proximate to the filtration assembly and configured to provide one or more spray streams into engagement with the filtration assembly.

11. The receiving station of claim 10, wherein the spray assembly includes a spray supply pipe that is couplable to a spray fluid source, and one or more spray nozzles that provide the one or more spray streams.

12. The receiving station of claim 10, wherein the spray assembly is further configured such that an initial spray angle of the one or more spray streams is selected so that the one or more spray streams engage onto the filtration assembly to apply fluidic pressure from the one or more spray streams onto the one or more filtered objects to at least partially assist the one or more filtered objects to be driven by gravity downwardly along the upper surface of the at least one filtration member and into the debris chute without assistance from a mechanical removal device.

13. A receiving station for at least partially filtering an inflow stream, comprising:
a containment vessel having an opening configured to receive the inflow stream;
an inflow assembly positioned proximate to the opening of the containment vessel and configured to provide the inflow stream into the containment vessel;
a filtration assembly disposed within the containment vessel and having at least one filtration member disposed at an inclination angle with respect to horizontal, the at least one filtration member positioned such that the inflow stream entering the opening of the containment vessel engages onto an upper surface thereof such that one or more filtered fluids pass through the at least one filtration member and one or more filtered objects are prevented from passing through the at least one filtration member; and
a debris removal assembly having a debris chute positioned to receive the one or more filtered objects, and a screw conveyor operatively disposed proximate the debris chute to convey the one or more filtered objects along the debris chute and out of the containment vessel;
wherein the inflow assembly, the filtration assembly, and the debris removal assembly are configured to enable the one or more filtered objects to be driven by gravity, and at least partially assisted by fluidic pressure from the inflow stream, downwardly along the upper surface of the at least one filtration member and into the debris chute without assistance from a mechanical removal device.

14. The receiving station of claim 13, further comprising a spray assembly positioned proximate to the filtration assembly and configured to provide one or more spray streams into engagement with the filtration assembly, the spray assembly being configured such that an initial spray angle of the one or more spray streams is selected so that the one or more spray streams engage onto the filtration assembly to apply fluidic pressure from the one or more spray streams onto the one or more filtered objects to at least partially assist the one or more filtered objects to be driven by gravity downwardly along the upper surface of the at least one filtration member and into the debris chute.

15. A receiving station for at least partially filtering an inflow stream, comprising:
a containment vessel having an opening configured to receive the inflow stream;
a filtration assembly disposed within the containment vessel and having at least one filtration member disposed at an inclination angle with respect to horizontal, the at least one filtration member positioned such that the inflow stream entering the opening of the containment vessel engages onto an upper surface thereof such that one or more filtered fluids pass through the at least one filtration member and one or more filtered objects are prevented from passing through the at least one filtration member;
a spray assembly positioned proximate to the filtration assembly and configured to provide one or more spray streams into engagement with the filtration assembly; and
a debris removal assembly having a debris chute positioned to receive the one or more filtered objects, and a screw conveyor operatively disposed proximate the debris chute to convey the one or more filtered objects along the debris chute and out of the containment vessel;
wherein the filtration assembly, the spray assembly, and the debris removal assembly are configured to enable the one or more filtered objects to be driven by gravity, and at least partially assisted by fluidic pressure from the one or more spray streams, downwardly along the upper surface of the at least one filtration member and into the debris chute without assistance from a mechanical removal device.

16. The receiving station of claim 15, further comprising an inflow assembly positioned proximate to the opening of the containment vessel and configured to provide the inflow stream into the containment vessel, the inflow assembly being configured such that an initial inflow angle of the inflow stream is selected so that the inflow stream engages onto the filtration assembly to apply fluidic pressure from the inflow stream onto the one or more filtered objects to at least partially assist the one or more filtered objects to be driven by gravity downwardly along the upper surface of the at least one filtration member and into the debris chute.
